(19) United States
(12) Patent Application Publication
(10) Pub. No.: US 2026/0176111 A1
(43) Pub. Date: Jun. 25, 2026

(54) CRANE

(71) Applicant: SUMITOMO HEAVY INDUSTRIES, LTD., Tokyo (JP)

(72) Inventors: Yasuhiro YAMAMOTO, Kanagawa (JP); Chunnan WU, Kanagawa (JP); Keita NAKAMORI, Kanagawa (JP); Takatoshi ITO, Kanagawa (JP); Hisashi OSUMI, Tokyo (JP)

(21) Appl. No.: 19/425,402

(22) Filed: Dec. 18, 2025

(30) Foreign Application Priority Data
Dec. 20, 2024 (JP) 2024-225497

(51) Int. Cl. B66C 13/48; B66C 13/06; B66C 13/46; B66C 23/88

(52) U.S. Cl. CPC B66C 13/48; B66C 13/06; B66C 13/46; B66C 23/88

(57) ABSTRACT

A crane includes: an upper structure provided so as to be capable of slewing; an attachment provided on the upper structure so as to be capable of being luffed; a hook that is hung so as to be capable of being raised and lowered via the attachment; an input device configured to input a designated path between a start position and an end position of transporting a suspended load with the hook; and a controller including: a memory; and a processor coupled to the memory and configured to generate a transport path for the suspended load from the start position to the end position via the designated path input to the input device.

### CROSS-REFERENCE TO RELATED APPLICATIONS

This application is based upon and claims priority to Japanese Patent Application No. 2024-225497, filed on Dec. 20, 2024, the entire contents of which are incorporated herein by reference.

### BACKGROUND

### 1. Technical Field

The present disclosure relates to a crane.

### 2. Description of Related Art

A crane that calculates a transport path for a load is known in the related art.

### SUMMARY

A crane includes: an upper structure provided so as to be capable of slewing; an attachment provided on the upper structure so as to be capable of being luffed; a hook that is hung so as to be capable of being raised and lowered via the attachment; an input device configured to input a designated path between a start position and an end position of transporting a suspended load with the hook; and a controller including: a memory; and a processor coupled to the memory and configured to generate a transport path for the suspended load from the start position to the end position via the designated path input to the input device.

### BRIEF DESCRIPTION OF THE DRAWINGS

FIG. 1 is a side view illustrating a crane according to an embodiment of the present disclosure;

FIG. 2 is a top view of an upper structure of the crane according to an embodiment of the present disclosure;

FIG. 3 is a side view illustrating the crane in a tower configuration according to an embodiment of the present disclosure;

FIG. 4 is a perspective view of an interior of an operator's compartment of the crane according to an embodiment of the present disclosure;

FIG. 5 is a block diagram of a hydraulic drive system of the crane according to an embodiment of the present disclosure;

FIG. 6 is a functional block diagram of the crane according to an embodiment of the present disclosure;

FIG. 7 is a flowchart illustrating example processing of the crane according to an embodiment of the present disclosure;

FIG. 8 is a schematic view of a display device illustrating example processing of inputting a designated path in FIG. 7;

FIG. 9 is an example image of a transport path in processing of displaying a transport path in FIG. 7;

FIG. 10 is an example image of a transport path in processing of correcting the transport path in FIG. 7;

FIG. 11 is an example image of a transport path in processing of correcting the transport path illustrated in FIG. 7; and

FIG. 12 is an example evaluation function used in processing of correcting the transport path in FIG. 7.

### DETAILED DESCRIPTION

The crane in the related art may disadvantageously present a transport path that does not match the operator's sense of operation.

The present disclosure provides a crane capable of automatically generating a transport path for a suspended load in conformity with the operator's sense of operation.

Hereinafter, embodiments of a crane according to the present disclosure will be described with reference to the drawings.

The embodiments described below are intended to be illustrative and not restrictive of the invention. Not all features and combinations of the embodiments of the present disclosure are necessarily essential to the invention. The same or corresponding components are denoted by the same or corresponding reference signs throughout the drawings, and the redundant description thereof may be omitted.

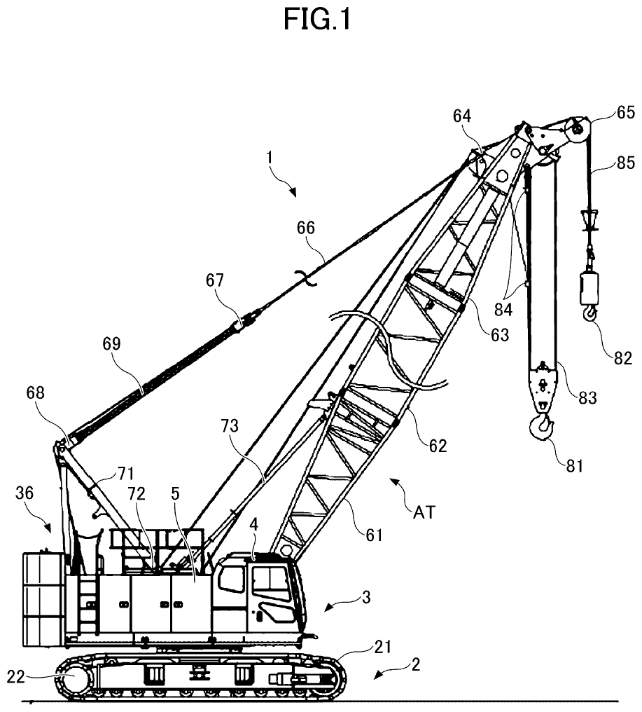

FIG. 1 is a side view illustrating a crane 1 according to an embodiment of the present disclosure. The crane 1 includes, for example, an undercarriage 2, an upper structure 3, and an attachment AT. The crane 1 illustrated in FIG. 1 is a mobile crane in a crane configuration and includes a lower boom 61, an intermediate boom 62, and an upper boom 63 as the attachment AT.

The undercarriage 2 includes, for example, left and right crawlers 21 and left-travel and right-travel devices 22. The crawlers 21 are driven by the travel devices 22 to rotate forward and rearward. The travel devices 22 are hydraulic actuators including hydraulic travel motors that are driven by hydraulic fluid under hydraulic pressure. By rotating the crawlers 21 forward or rearward, the crane 1 travels forward or rearward.

The upper structure 3 is provided on the undercarriage 2 so as to be capable of slewing. The upper structure 3 includes an operator's compartment 4 that is provided laterally to the attachment AT.

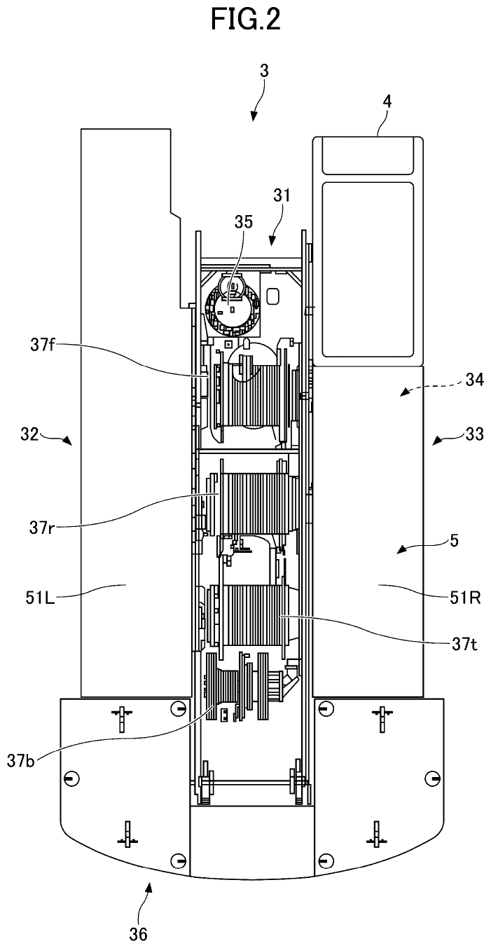

FIG. 2 is a top view of the upper structure 3 of the crane 1 illustrated in FIG. 1. Note that in FIG. 2, illustration of some components of the crane 1 illustrated in FIG. 1, including the attachment AT, is omitted. As illustrated in FIG. 2, the upper structure 3 includes, for example, an upper frame 31 and beds 32 and 33. Specifically, the upper structure 3 has the upper frame 31 that is provided on the undercarriage 2 so as to be capable of slewing, and the left and right beds 32 and 33 that are coupled to opposite sides of the upper frame 31.

A slew device 35 is provided at a front end of the upper frame 31, and a counterweight 36 is mounted at a rear end of the upper frame 31. The upper frame 31 is provided with, for example, a front winch 37f, a rear winch 37r, a third winch 37t, and a boom-luffing winch 37b. Note that the third winch 37t is optional in the crane 1.

The slew device 35 is, for example, a hydraulic actuator including a slew motor that is driven by hydraulic fluid under hydraulic pressure, and causes the upper frame 31, which is mounted on the undercarriage 2 so as to be capable of slewing, to slew relative to the undercarriage 2. The counterweight 36 may be, for example, a welded counterweight or a cast counterweight.

The front winch 37f, the rear winch 37r, the third winch 37t, and the boom-luffing winch 37b are, for example, hydraulic actuators including hydraulic motors that are driven by hydraulic fluid under hydraulic pressure. These winches wind a front-drum wire rope 83, a rear-drum wire rope 85, a boom-luffing wire rope 69, and the like illustrated in FIG. 1.

The left bed 32 is coupled to the left side of the upper frame 31 and is included in the left side of the upper structure 3. The right bed 33 is coupled to the right side of the upper frame 31 and is included in the right side of the upper structure 3. In an example illustrated in FIG. 2, the right bed 33 is located on the operator's compartment 4 side of the upper structure 3. The left and right beds 32 and 33 are provided with a house 5 that houses various kinds of devices mounted on the upper structure 3.

The house 5 has a removable left cover 51L that covers electrical devices and the like mounted on the left bed 32. The house 5 has a removable right cover 51R that covers various kinds of devices mounted on the right bed 33.

The operator's compartment 4 is provided, for example, at a front end of the right bed 33 and is located on the right side of the attachment AT. The operator's compartment 4 is also referred to as a cabin or a cab. Note that the operator's compartment 4 may be provided at a front end of the left bed 32 and located on the left side of the attachment AT.

The attachment AT is provided on the upper structure 3 so as to be capable of being luffed. Specifically, the attachment AT is attached to the front end of the upper frame 31, for example, via a boom foot pin disposed parallel to a width direction of the upper structure 3. In the crane 1 in a crane configuration as illustrated in FIG. 1, the attachment AT includes the lower boom 61, the intermediate boom 62, and the upper boom 63.

The lower boom 61 is mounted on the upper frame 31 of the upper structure 3 so as to be capable of pivoting forward and rearward with respect to the upper frame 31. The intermediate boom 62 is attached to a distal end of the lower boom 61. The upper boom 63 has a guide sheave 64 and an auxiliary sheave 65, and is attached to a distal end of the intermediate boom 62. The height of the attachment AT can be changed by increasing or decreasing the number of intermediate booms 62 arranged between the lower boom 61 and the upper boom 63.

Moreover, the crane 1 in a crane configuration as illustrated in FIG. 1 has a pendant rope 66, an upper spreader 67, a lower spreader 68, the boom-luffing wire rope 69, a gantry 71, a gantry raising/lowering cylinder 72, and a backstop 73. One end of the pendant rope 66 is connected to a rear portion of the distal end of the upper boom 63, and the other end is connected to the upper spreader 67. The lower spreader 68 is attached to a distal end of the gantry 71, which is provided on the upper frame 31 so as to be capable of being raised and lowered. The gantry raising/lowering cylinder 72 is provided on the upper frame 31 in order to raise and lower the gantry 71. The boom-luffing wire rope 69 is reeved between the upper spreader 67 and the lower spreader 68, and is wound on the boom-luffing winch 37b.

With the gantry 71 erected by the gantry raising/lowering cylinder 72, the attachment AT can be pivoted rearward and upward into an erected position by winding the boom-luffing wire rope 69 with the boom-luffing winch 37b. In this case, rearward pivoting of the attachment AT is limited by the backstop 73. By unwinding the boom-luffing wire rope 69 with the boom-luffing winch 37b, the attachment AT can be pivoted forward and downward into a forward-tilted position. Moreover, the crane 1 in a crane configuration as illustrated in FIG. 1 has a boom hook 81, a jib hook 82, the front-drum wire rope 83, an anti-two-block (ATB) device 84, and the rear-drum wire rope 85.

The front-drum wire rope 83 is reeved over the boom hook 81 and wound on the front winch 37f. The ATB device 84 is provided on the front-drum wire rope 83. The rear-drum wire rope 85 is connected to the jib hook 82 and wound on the rear winch 37r.

By winding the front-drum wire rope 83 with the front winch 37f, the boom hook 81 can be raised to hoist a suspended load. In this case, the ATB device 84 prevents excessive raising of the boom hook 81. By unwinding the front-drum wire rope 83 with the front winch 37f, the boom hook 81 can be lowered to lower the suspended load.

Similarly, by winding the rear-drum wire rope 85 with the rear winch 37r, the jib hook 82 can be raised to hoist the suspended load. By unwinding the rear-drum wire rope 85 with the rear winch 37r, the jib hook 82 can be lowered to lower the suspended load.

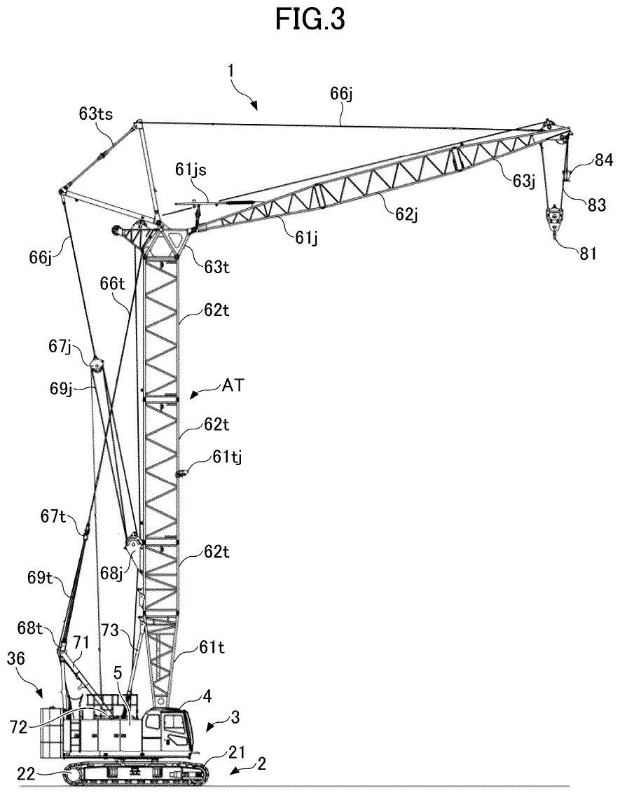

FIG. 3 is a side view illustrating the crane 1 of FIG. 1 in a tower configuration. In the crane 1 in a tower configuration, the attachment AT includes a lower tower boom 61t, an intermediate tower boom 62t, an upper tower boom 63t, a lower tower jib 61j, an intermediate tower jib 62j, and an upper tower jib 63j. The lower tower boom 61t is mounted on the upper frame 31 of the upper structure 3 so as to be capable of pivoting forward and rearward with respect to the upper frame 31. The intermediate tower boom 62t is attached to a distal end of the lower tower boom 61t. The upper tower boom 63t has a tower strut 63ts and is attached to a distal end of the intermediate tower boom 62t. The height of the attachment AT can be changed by increasing or decreasing the number of intermediate tower booms 62t arranged between the lower tower boom 61t and the upper tower boom 63t.

The lower tower jib 61j has a tower-jib backstop 61js and is attached to the upper tower boom 63t so as to be capable of being luffed with respect to the upper tower boom 63t. The intermediate tower jib 62j is attached to a distal end of the lower tower jib 61j. The upper tower jib 63j is attached to a distal end of the intermediate tower jib 62j.

Moreover, the crane 1 in a tower configuration as illustrated in FIG. 3 has a tower-jib pendant rope 66j, an upper tower-jib spreader 67j, a lower tower-jib spreader 68j, and a tower-jib-luffing wire rope 69j.

The tower-jib pendant rope 66j is reeved between a distal end of the upper tower jib 63j and the tower strut 63ts, and further between the tower strut 63ts and the upper tower-jib spreader 67j. The lower tower-jib spreader 68j is attached to a rear portion of the intermediate tower boom 62t that is coupled to the distal end of the lower tower boom 61t. The tower-jib-luffing wire rope 69j is reeved between the upper tower-jib spreader 67j and the lower tower-jib spreader 68j, and is wound on a rear winch 37r.

By winding the tower-jib-luffing wire rope 69j with the rear winch 37r, a tower jib including the lower tower jib 61j, the intermediate tower jib 62j, and the upper tower jib 63j is pivoted rearward and upward into an erected position with respect to a tower boom including the lower tower boom 61t, the intermediate tower boom 62t, and the upper tower boom 63t. In this case, rearward pivoting of the tower jib is limited by the tower-jib backstop 61js. By unwinding the tower-jib-luffing wire rope 69j with the rear winch 37r, the tower jib is pivoted forward and downward.

Moreover, the crane 1 in a tower configuration as illustrated in FIG. 3 has a tower pendant rope 66t, an upper tower spreader 67t, a lower tower spreader 68t, and a tower-luffing wire rope 69t.

One end of the tower pendant rope 66t is connected to a rear portion of the upper tower boom 63t, and the other end is connected to the upper tower spreader 67t. The lower tower spreader 68t is attached to a distal end of the gantry 71, which is provided on the upper frame 31 so as to be capable of being raised and lowered. The tower-luffing wire rope 69t is reeved between the upper tower spreader 67t and the lower tower spreader 68t, and is wound on a boom-luffing winch 37b.

With the gantry 71 erected by a gantry raising/lowering cylinder 72, the attachment AT can be pivoted rearward and upward into an erected position by winding the tower-luffing wire rope 69t with the boom-luffing winch 37b. In this case, rearward pivoting of the attachment AT is restricted by a backstop 73. By unwinding the tower-luffing wire rope 69t with the boom-luffing winch 37b, the attachment AT can be pivoted forward and downward into a forward-tilted position.

Similar to the crane 1 in a crane configuration as illustrated in FIG. 1, the crane 1 in a tower configuration as illustrated in FIG. 3 has a boom hook 81, a front-drum wire rope 83, and an ATB device 84. Accordingly, by winding the front-drum wire rope 83 with the front winch 37f, the boom hook 81 can be raised to hoist a suspended load. In this case, the ATB device 84 prevents excessive raising of the boom hook 81. By unwinding the front-drum wire rope 83 with a front winch 37f, the boom hook 81 can be lowered to lower the suspended load.

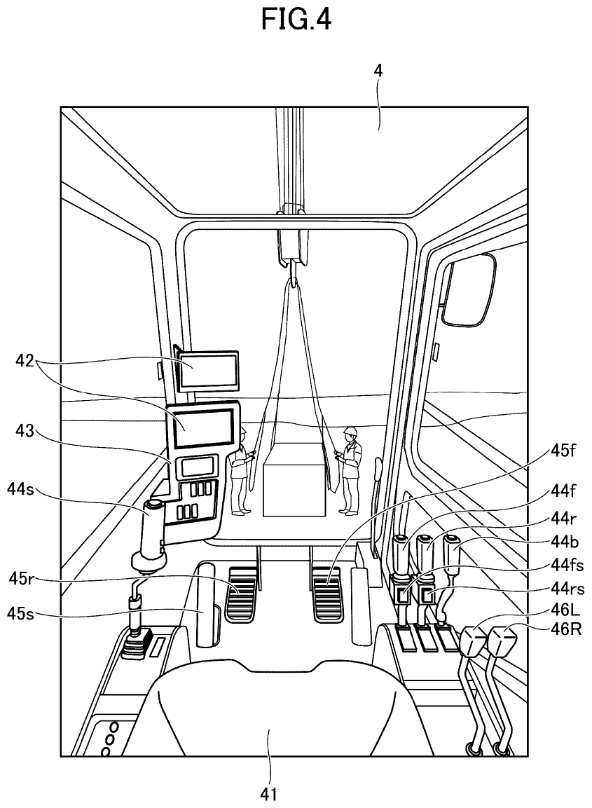

FIG. 4 is a perspective view of an interior of the operator's compartment 4 of the crane 1 illustrated in FIGS. 1. to 3. An operator's seat 41 on which the operator of the crane 1 sits is installed inside the operator's compartment 4. The longitudinal, lateral, and vertical directions of the crane 1 according to the present embodiment are, for example, the front-rear, left-right, and up-down directions as viewed by the operator sitting on the operator's seat 41. Various operating devices for operating the crane 1 are provided around the operator's seat 41.

Specifically, the operating devices of the crane 1 include, for example, a display device 42, a switch panel 43, a slew control lever 44s, a front-winch control lever 44f, a rear-winch control lever 44r, and a boom-luffing winch control lever 44b. The operating devices of the crane 1 further include, for example, a slew brake pedal 45s, a front-winch brake pedal 45f, a rear-winch brake pedal 45r, a left-travel control lever 46L, and a right-travel control lever 46R.

The display device 42 includes, for example, a touch panel, and displays an image of the surroundings of the crane 1 and displays information regarding overload prevention. The switch panel 43 receives various operations performed by the operator. The slew control lever 44s is used to slew the upper structure 3 with a slew device 35.

The front-winch control lever 44f is used to raise and lower the boom hook 81 with the front winch 37f. The rear-winch control lever 44r is used to raise and lower the jib hook 82 with the rear winch 37r and to luff the tower jib of the attachment AT in the tower configuration. The boom-luffing winch control lever 44b is used to luff the lower boom 61, the intermediate boom 62, and the upper boom 63, or to luff the lower tower boom 61t, the intermediate tower boom 62t, and the upper tower boom 63t.

The front-winch control lever 44f and the rear-winch control lever 44r may have a selector switch 44fs and a selector switch 44rs, respectively. The selector switch 44fs of the front-winch control lever 44f is used to switch the brake mode of the front winch 37f, and the selector switch 44rs of the rear-winch control lever 44r is used to switch the brake mode of the rear winch 37r.

The slew brake pedal 45s is used to apply braking to the upper structure 3 during slewing. The front-winch brake pedal 45f is used to apply rotational braking to the front winch 37f when the boom hook 81 is lowered with rotation of the front winch 37f being unlocked. The rear-winch brake pedal 45r is used to apply rotational braking to the rear winch 37r when the jib hook 82 is lowered with rotation of the rear winch 37r being unlocked. The left-travel control lever 46L is used to operate a left-travel device 22 included in the undercarriage 2. The right-travel control lever 46R is used to operate a right-travel device 22 included in the undercarriage 2.

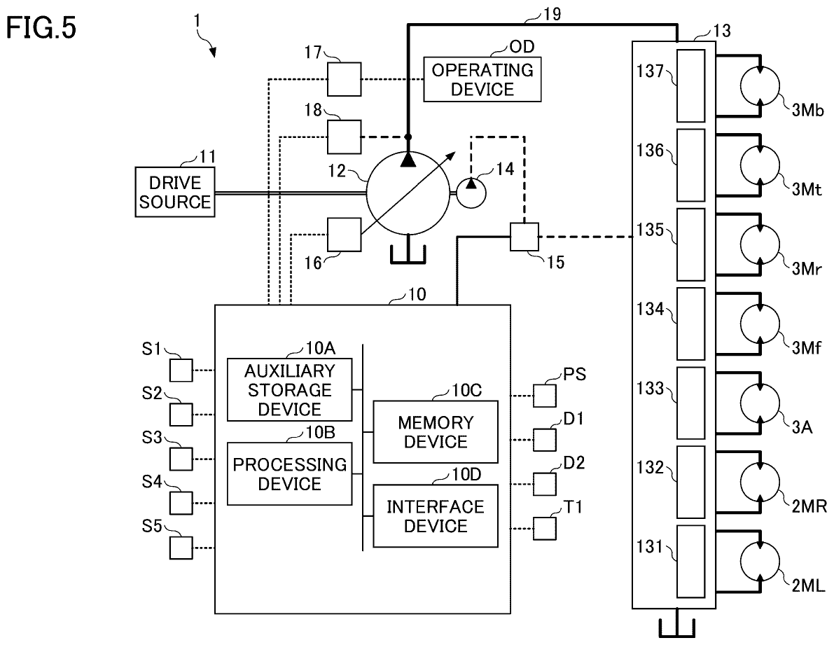

FIG. 5 is a block diagram of a hydraulic drive system and a control system of the crane 1 illustrated in FIGS. 1 to 4. In FIG. 5, a double line indicates transmission of mechanical power, and a solid line indicates a high-pressure hydraulic path. A broken line indicates a pilot-pressure transmission path, and a dotted line indicates a transmission path for electric and control signals.

The hydraulic drive system of the crane 1 includes hydraulic actuators to drive the undercarriage 2, the upper structure 3, the attachment AT, the boom hook 81, the jib hook 82, and the like. Specifically, the hydraulic actuators of the crane 1 include, for example, hydraulic motors such as a left-travel motor 2ML, a right-travel motor 2MR, a slew motor 3A, a front motor 3Mf, a rear motor 3Mr, a third motor 3Mt, and a boom-luffing motor 3Mb.

The left-travel motor 2ML is incorporated in the left-travel device 22 of the undercarriage 2 and generates power to rotate the left crawler 21 forward and rearward. The right-travel motor 2MR is incorporated in the right-travel device 22 of the undercarriage 2 and generates power to rotate the right crawler 21 forward and rearward. The slew motor 3A is incorporated in the slew device 35 illustrated in FIG. 2 and generates power to slew the upper structure 3 relative to the undercarriage 2.

The front motor 3Mf is incorporated in the front winch 37f illustrated in FIG. 2. The front motor 3Mf generates power to raise or lower the boom hook 81 by winding or unwinding the front-drum wire rope 83.

The rear motor 3Mr is incorporated in the rear winch 37r illustrated in FIG. 2. In the crane 1 in a crane configuration as illustrated in FIG. 1, the rear motor 3Mr generates power to raise or lower the jib hook 82 by winding or unwinding the rear-drum wire rope 85. In the crane 1 in a tower configuration as illustrated in FIG. 3, the rear motor 3Mr generates power to luff the attachment AT including the tower boom and the tower jib by winding or unwinding the tower-jib-luffing wire rope 69j.

The third motor 3Mt is incorporated in the third winch 37t illustrated in FIG. 2 and generates power to wind or unwind the wire rope wound on the third winch 37t.

The boom-luffing motor 3Mb is incorporated in the boom-luffing winch 37b illustrated in FIG. 2. The boom-luffing motor 3Mb generates power to luff the attachment AT including the lower boom 61, the intermediate boom 62, and the upper boom 63 by winding or unwinding the boom-luffing wire rope 69, as illustrated in the crane configuration of FIG. 1.

The hydraulic drive system of the crane 1 includes a drive source 11, a main pump 12, a control valve unit 13, a pilot pump 14, and a proportional control valve 15. The control system of the crane 1 includes a controller 10, a regulator 16, an operating device OD, an operation sensor 17, and a discharge-pressure sensor 18.

The drive source 11 is the main drive source in the hydraulic drive system, and is mounted, for example, at a rear portion of the upper structure 3. Specifically, the drive source 11 is rotated at a preset target rotational speed under direct or indirect control of the controller 10 to drive the main pump 12 and the pilot pump 14. The drive source 11 is, for example, an engine. Specifically, the drive source 11 is, for example, a diesel engine fueled by diesel. Note that the drive source 11 may be a gasoline engine, a hydrogen engine, or the like. The drive source 11 may be a combination of a power supply, such as a battery or a fuel cell, and an electric motor.

Similar to the drive source 11, the main pump 12 is mounted, for example, at the rear portion of the upper structure 3. The main pump 12 is a hydraulic pump configured to supply hydraulic fluid to the control valve unit 13 through a high-pressure hydraulic line 19. The main pump 12 is driven by the drive source 11 as described above. The main pump 12 is, for example, a variable displacement hydraulic pump. As described above, in the main pump 12, the stroke length of a piston may be adjusted by the regulator 16, which adjusts the tilt angle of a swash plate under the control of the controller 10 to control the discharge amount or the discharge pressure.

The control valve unit 13 is a hydraulic control device configured to control the hydraulic system in the crane 1. In the present embodiment, the control valve unit 13 includes control valves 131 to 137. The control valve unit 13 is configured to selectively supply hydraulic fluid discharged from the main pump 12 to one or more hydraulic actuators through the control valves 131 to 137.

The control valves 131 to 137 control the flow rate of hydraulic fluid flowing from the main pump 12 to the hydraulic actuators and the flow rate of hydraulic fluid flowing from corresponding hydraulic actuators to a hydraulic reservoir. More specifically, the control valves 131, 132, and 133 correspond to the left-travel motor 2ML, the right-travel motor 2MR, and the slew motor 3A, respectively. Moreover, the control valves 134, 135, 136, and 137 correspond to the front motor 3Mf, the rear motor 3Mr, the third motor 3Mt, and the boom-luffing motor 3Mb, respectively.

The pilot pump 14 is an example of a pilot-pressure generation device and is configured to supply hydraulic fluid to the hydraulic control devices via a pilot line. In the present embodiment, the pilot pump 14 is a fixed displacement hydraulic pump. Note that the pilot-pressure generation device may be implemented by the main pump 12. That is, the main pump 12 may have a function of supplying hydraulic fluid to various hydraulic control devices via the pilot line in addition to a function of supplying hydraulic fluid to the control valve unit 13 via a hydraulic line. In this case, the pilot pump 14 may be omitted.

The proportional control valve 15 functions as a control valve for machine control. The proportional control valve 15 is disposed in a conduit connecting the pilot pump 14 and the pilot ports of the control valves 131 to 137 in the control valve unit 13, and is configured to vary the flow-path area of the conduit. In the present embodiment, the proportional control valve 15 operates in accordance with a control command output from the controller 10. This enables the controller 10 to supply hydraulic fluid discharged from the pilot pump 14 to the pilot ports of the control valves 131 to 137 in the control valve unit 13 via the proportional control valve 15 independently of the operation of the operating device OD performed by the operator.

With this configuration, the controller 10 can operate a hydraulic actuator corresponding to a specific operating device OD even when the specific operating device OD is not operated. In a case where the crane 1 does not have a machine control function or a remote control function, the proportional control valve 15 is optional in the crane 1.

The regulator 16 controls the discharge amount of the main pump 12 serving as a hydraulic pump. In accordance with a control command from the controller 10, the regulator 16 adjusts the angle of the swash plate of the main pump 12, that is, the tilt angle, to control the displacement of the hydraulic fluid by the main pump 12 and then control the discharge amount of the hydraulic fluid by the main pump 12.

The operating device OD is a device used by the operator to operate the actuators. The operating device OD includes, for example, the slew control lever 44s, the front-winch control lever 44f, the rear-winch control lever 44r, and the boom-luffing winch control lever 44b, which are illustrated in FIG. 4. The operating device OD further includes, for example, the slew brake pedal 45s, the front-winch brake pedal 45f, the rear-winch brake pedal 45r, the left-travel control lever 46L, and the right-travel control lever 46R.

The operation sensor 17 is configured to detect the operations performed by the operator using the operating device OD. In the present embodiment, the operation sensor 17 detects the operation direction and the operation amount of the operating device OD corresponding to each of the actuators, and outputs the detected values to the controller 10.

The discharge-pressure sensor 18 is configured to detect a discharge pressure of the main pump 12. In the present embodiment, the discharge-pressure sensor 18 outputs, to the controller 10, a signal indicative of the detected discharge pressure of the main pump 12.

For example, the controller 10 is provided in the operator's compartment 4 and configured to perform drive control of the crane 1. The controller 10 includes, for example, an auxiliary storage device 10A (e.g., a read-only memory (ROM)), a processing device 10B (e.g., a central processing unit (CPU)), a memory device 10C (e.g., a random access memory (RAM)), and an interface device 10D for communicating with different devices. The controller 10 is, for example, a controller configured to control various components of the crane 1. The controller 10 may be implemented as a single controller or a plurality of controllers.

The controller 10 controls an opening area of the proportional control valve 15 in accordance with an output of the operation sensor 17. Then, the controller 10 supplies the hydraulic fluid discharged from the pilot pump 14 to the pilot ports of the corresponding control valves 131 to 137 in the control valve unit 13. In principle, the pressure of the hydraulic fluid supplied to each pilot port (pilot pressure) corresponds to the operation direction and operation amount of the operation sensor 17 for the hydraulic actuator corresponding to the pilot port. As described above, the operating device OD is configured to supply the hydraulic fluid discharged from the pilot pump 14 to the pilot ports of the corresponding control valves 131 to 137 in the control valve unit 13.

Moreover, the control system of the crane 1 includes, for example, a slew sensor S1, a boom-luffing sensor S2, a tower-jib-luffing sensor S3, a length sensor S4, a sway sensor S5, a positioning device PS, a display device D1, an input device D2, and a communication device T1.

The slew sensor S1 outputs information on the slewing of the upper structure 3. The slew sensor S1 detects, for example, slewing angular velocity of the upper structure 3 relative to the undercarriage 2. The slew sensor S1 also detects a slewing angle. The slew sensor S1 may be, for example, a gyro sensor, a resolver, a rotary encoder, or an inertial measurement unit (IMU). A signal indicative of the slewing angle or the slewing angular velocity of the upper structure 3 detected by the slew sensor S1 is input to the controller 10.

The boom-luffing sensor S2 detects a luffing angle of the lower boom 61 or the lower tower boom 61t, that is, a tilt angle relative to the upper structure 3. The boom-luffing sensor S2 may be, for example, a gyro sensor, a resolver, a rotary encoder, or an IMU. A signal indicative of the luffing angle of the lower boom 61 or the lower tower boom 61t detected by the boom-luffing sensor S2 is input to the controller 10.

The tower-jib-luffing sensor S3 detects a luffing angle of the lower tower jib 61j, that is, a tilt angle of the lower tower jib 61j relative to the upper tower boom 63t. The tower-jib-luffing sensor S3 may be, for example, a gyro sensor, a resolver, a rotary encoder, or an IMU. A signal indicative of the luffing angle of the lower tower jib 61j detected by the tower-jib-luffing sensor S3 is input to the controller 10.

The length sensor S4 detects, for example, a length of a wire rope, such as the front-drum wire rope 83 or the rear-drum wire rope 85, hanging from the sheave at the distal end of the attachment AT. The length sensor S4 may be, for example, a gyro sensor, a resolver, a rotary encoder, or an IMU, each of which detects a rotation of the drum of the front winch 37f. Alternatively, the length sensor S4 may be, for example, a distance sensor configured to detect a distance from the sheave at the distal end of the attachment AT to a hook such as the boom hook 81 or the jib hook 82. A signal indicative of the length of the wire rope detected by the length sensor S4 is input to the controller 10.

The sway sensor S5 detects, for example, a sway angle and a corresponding sway angular velocity of a hook of the crane 1, such as the boom hook 81 or the jib hook 82. The sway sensor S5 may include, for example, a gyro sensor attached to the hook, or an image-capturing device attached to the distal end of the attachment AT. A signal indicative of the sway angle and the corresponding sway angular velocity of the hook detected by the sway sensor S5 is input to the controller 10.

The positioning device PS is configured to acquire information on a position of the crane 1. In the present embodiment, the positioning device PS is configured to measure a position and orientation of the crane 1. Specifically, the positioning device PS is a global navigation satellite system (GNSS) receiver incorporating an electronic compass, and measures the latitude, longitude, and altitude of the current position of the crane 1, as well as the orientation of the crane 1.

The display device D1 is provided in the operator's compartment 4 at a position easily viewable by the seated operator, and displays various informational images under the control of the controller 10. The display device D1 includes, for example, the display device 42 illustrated in FIG. 4. The display device D1 may be connected to the controller 10 via an on-vehicle communication network such as a controller area network (CAN), or may be connected to the controller 10 via a dedicated one-to-one line. The display device D1 is not limited to the display device 42 provided in advance in the operator's compartment 4, and may be a detachable monitor. The display device D1 may be, for example, a mobile information terminal such as a tablet personal computer (PC) capable of communicating with the communication device T1.

The input device D2 is provided within reach of the seated operator in the operator's compartment 4, receives various operation inputs from the operator, and outputs, to the controller 10, a signal indicative of each operation input. The input device D2 includes a touch panel and a knob switch. The touch panel is mounted on a display of the display device D1 that includes the display device 42 configured to display various informational images, and the knob switch is provided at the tip of a lever device such as the slew control lever 44s. The input device D2 also includes a button switch, a lever, a toggle, a rotary dial, and the like provided around the display device 42 installed in the operator's compartment 4. A signal indicative of the operation performed with the input device D2 is input to the controller 10.

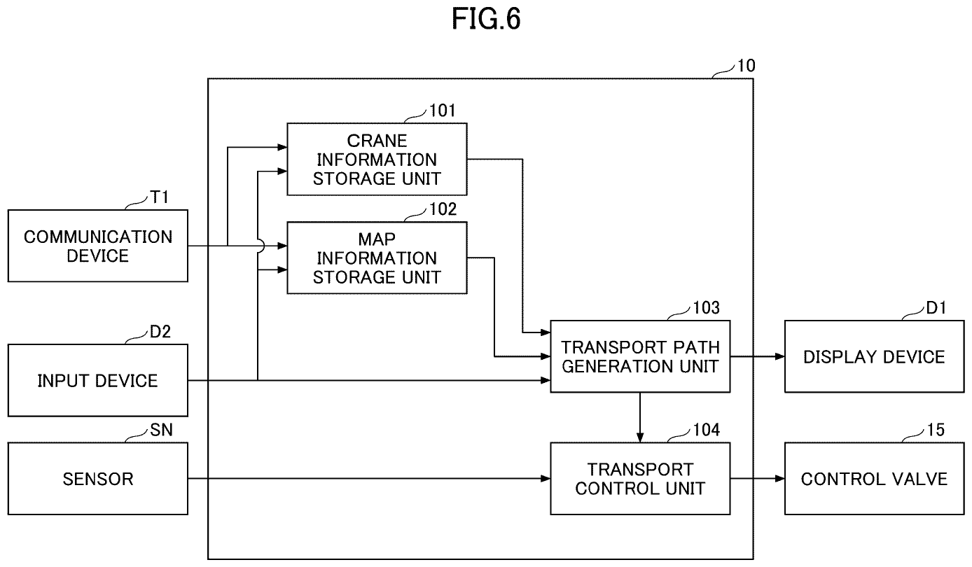

The communication device T1 communicates with an external device through a predetermined network including a mobile communication network, a satellite communication network, an Internet network, or the like. The communication device T1 is, for example, a mobile communication module complying with mobile communication standards such as Long Term Evolution (LTE), 4th Generation (4G), or 5th Generation (5G), and/or a satellite communication module for connecting to a satellite communication network. FIG. 6 is a functional block diagram of the controller 10 illustrated in FIG. 5. Note that a sensor SN in FIG. 6 includes the slew sensor S1, the boom-luffing sensor S2, the tower-jib-luffing sensor S3, the length sensor S4, the sway sensor S5, and the positioning device PS, which are as illustrated in FIG. 5.

As illustrated in FIG. 6, the controller 10 includes, for example, a crane information storage unit 101, a map information storage unit 102, a transport path generation unit 103, and a transport control unit 104. Each unit of the controller 10 represents, for example, each function of the controller 10 implemented by loading a program stored in the auxiliary storage device 10A onto the memory device 10C by the processing device 10B and executing the program. Note that each unit of the controller 10 illustrated in FIG. 6 may be implemented by a single controller or a plurality of different controllers.

The crane information storage unit 101 receives, for example, three-dimensional information including the dimensions and the movable range of each component of the crane 1 via the communication device T1 or the input device D2. The crane information storage unit 101 stores, in the auxiliary storage device 10A or the memory device 10C, the three-dimensional information on the crane 1 received via the communication device T1 or the input device D2.

The map information storage unit 102 receives, via the communication device T1 or the input device D2, for example, three-dimensional map information on a work site where the crane 1 operates. The map information storage unit 102 stores, in the auxiliary storage device 10A or the memory device 10C, the map information received via the communication device T1 or the input device D2.

The transport path generation unit 103 generates a transport path for the suspended load of the crane 1 based on the three-dimensional information including the movable range of the crane 1 stored in the crane information storage unit 101, the three-dimensional map information stored in the map information storage unit 102, and a designated path received via the input device D2.

Specifically, the input device D2 is configured to input a designated path between a start position and an end position of transporting a suspended load with a hook of the crane 1 such as the boom hook 81. The transport path generation unit 103 generates a transport path for the suspended load from the transport start position to the transport end position via the designated path input to the input device D2. Although the details will be described later, the designated path input by the operator of the crane 1 via the input device D2 is information on the position or path of the suspended load for generating a transport path that conforms to the operator's sense and intention of operation.

The transport path generation unit 103 also outputs, to the display device D1 including the display device 42 in the operator's compartment 4, the generated image information on the transport path for the suspended load. Accordingly, an image of the transport path generated by the transport path generation unit 103 is displayed on the display device D1 including the display device 42. The transport path generation unit 103 also outputs, to the transport control unit 104, the generated information on the transport path for the suspended load.

The transport control unit 104 acquires the information on the transport path for the suspended load output from the transport path generation unit 103. The transport control unit 104 controls the actuators of the crane 1 so that the suspended load hooked to a hook of the crane 1, such as the boom hook 81, is moved following the transport path acquired from the transport path generation unit 103. Specifically, the transport control unit 104 generates a control command for moving the suspended load following the transport path, and outputs the control command to the proportional control valve 15.

The proportional control valve 15 controls the pilot pressure of the hydraulic fluid supplied from the pilot pump 14 to the control valve in the control valve unit 13 in accordance with the control command input from the transport control unit 104. Then, the flow rate and direction of the hydraulic fluid supplied from the main pump 12 to the hydraulic actuators, such as the slew motor 3A, the front motor 3Mf, the rear motor 3Mr, and the boom-luffing motor 3Mb, are controlled by the control valve in the control valve unit 13. As a result, slewing of the upper structure 3, luffing of the attachment AT, and raising or lowering of the hook, such as the boom hook 81, are performed by the hydraulic actuators, and the suspended load hooked to the hook is moved following the transport path generated by the transport path generation unit 103.

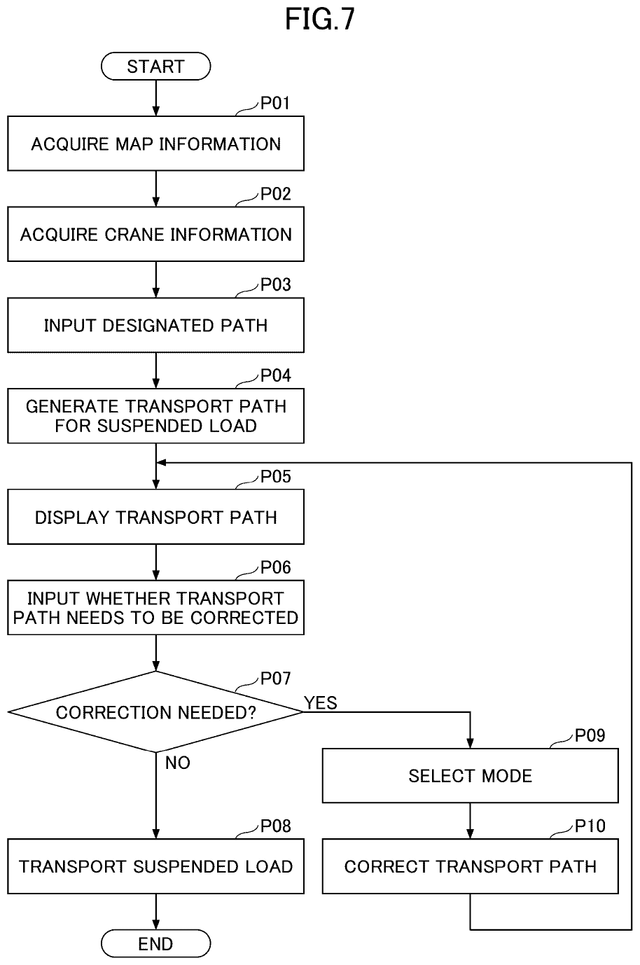

Next, example processing performed by the controller 10 of the crane 1 according to the present embodiment will be described with reference to FIGS. 7 to 11.

FIG. 7 is a flowchart illustrating a flow of processing performed by the controller 10 to generate a transport path for a suspended load. Upon starting the processing flow illustrated in FIG. 7, the controller 10 executes Processing P01 to acquire map information and Processing P02 to acquire crane information. Specifically, in Processing P01, the transport path generation unit 103 of the controller 10 acquires three-dimensional map information on a work site from the map information storage unit 102. In Processing P02, the transport path generation unit 103 further acquires three-dimensional information on the crane 1 including the shape, dimensions, position, attitude, and movable range of each component of the crane 1 from the crane information storage unit 101. Next, the controller 10 executes Processing P03 to input a designated path.

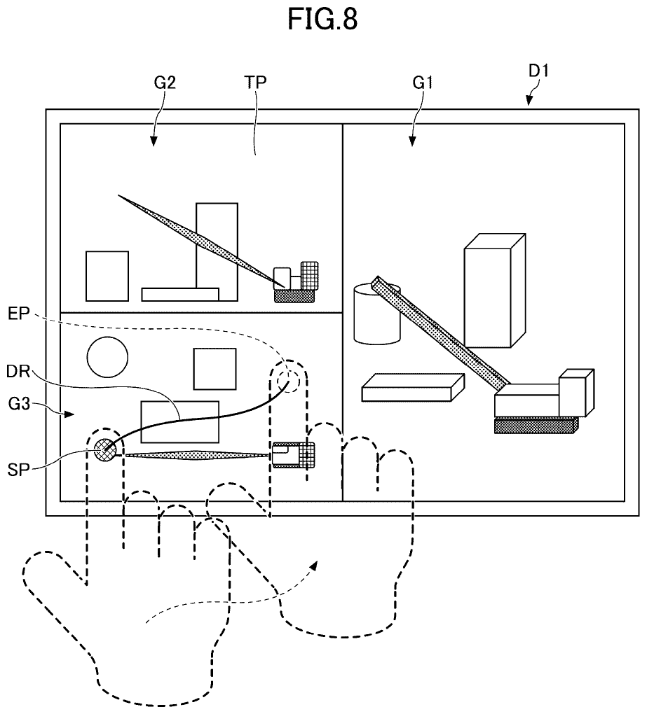

FIG. 8 is a schematic view of the display device D1 illustrating an example of Processing P03 for inputting a designated path illustrated in FIG. 7. In Processing P03, the transport path generation unit 103 receives an input of a designated path DR performed by the operator through, for example, a touch panel TP serving as the input device D2 provided on the display device D1 such as the display device 42 in the operator's compartment 4. Note that the transport path generation unit 103 may receive an input of the designated path DR through, for example, the input device D2 such as a mouse or a cursor key, instead of the touch panel TP.

In the example illustrated in FIG. 8, the transport path generation unit 103 causes the display device D1 to display images of the crane 1 and obstacles surrounding the crane 1 based on the three-dimensional information on the crane 1 and the three-dimensional map information on the work site. More specifically, in the example illustrated in FIG. 8, a perspective view G1 of the crane 1 and the work site is displayed at the right half of the screen of the display device D1. A side view G2 of the crane 1 and the work site is displayed at the upper left of the screen of the display device D1, and a plan view G3 of the crane 1 and the work site is displayed at the lower left of the screen of the display device D1.

In the example illustrated in FIG. 8, the operator, for example, traces, with his/her finger, a space between the start position SP and the end position EP of transporting the suspended load on the plan view G3 at the lower left of the screen of the display device D1, and inputs the designated path DR that conforms to his sense and intention of operation by using the touch panel TP. Herein, the designated path DR input by the operator to the transport path generation unit 103 via the input device D2, such as the touch panel TP, includes, for example, one or more points in a three-dimensional coordinate system.

Specifically, the designated path DR may be a straight line or a curved line in a three-dimensional orthogonal coordinate system that indicates all or part of the transport path for the suspended load, or may be one or more points in a three-dimensional orthogonal coordinate system that specify a position through which the suspended load passes. When the designated path DR is input by using the plan view G3, the height of the designated path DR is automatically calculated by the transport path generation unit 103 based on initial settings such as a preset minimum distance between an obstacle OB and the suspended load, or is separately input by the operator via the input device D2.

The operator may input, via the touch panel TP, the start position SP and the end position EP of transporting the suspended load transported by the crane 1. In this case, for example, the position where the operator first touches the touch panel TP with his/her fingertip is input as the start position SP. The current position of a hook of the crane 1, such as the boom hook 81 or the jib hook 82, may be registered as the start position SP of transporting the suspended load. The current position of the hook of the crane 1 can be acquired, for example, from the detection results of the slew sensor S1, the boom-luffing sensor S2, the tower-jib-luffing sensor S3, the length sensor S4, the positioning device PS, and the like.

Next, for example, the operator inputs the designated path DR by moving his/her fingertip from the start position SP on the touch panel TP. Ultimately, a position where the operator releases his/her fingertip from the touch panel TP is input as the end position EP. Note that the start position SP and the end position EP of transporting the suspended load with the crane 1 may be input to the transport path generation unit 103 through the input device D2 or the communication device T1 in advance before the designated path DR is input. In this case as well, the current position of a hook of the crane 1 can be set as the start position SP of transporting the suspended load.

Next, as illustrated in FIG. 7, the controller 10 executes Processing P04 to generate a transport path for the suspended load. In Processing P04, the transport path generation unit 103 generates a transport path for the suspended load from the start position SP of transporting the suspended load to the end position EP of transporting the suspended load via the designated path DR input to the input device D2 in Processing P03. This transport path is an initial path first generated by the controller 10 based on the designated path DR. Note that “via the designated path DR” includes passing through the designated path DR and passing through a point within a predetermined distance from the designated path DR.

Next, as illustrated in FIG. 7, the controller 10 executes Processing P05 to display the generated transport path. In Processing P05, the transport path generation unit 103 generates image data of the transport path generated in Processing P04, outputs the image data to the display device D1 including the display device 42 in the operator's compartment 4, and causes the display device D1 to display an image of the transport path.

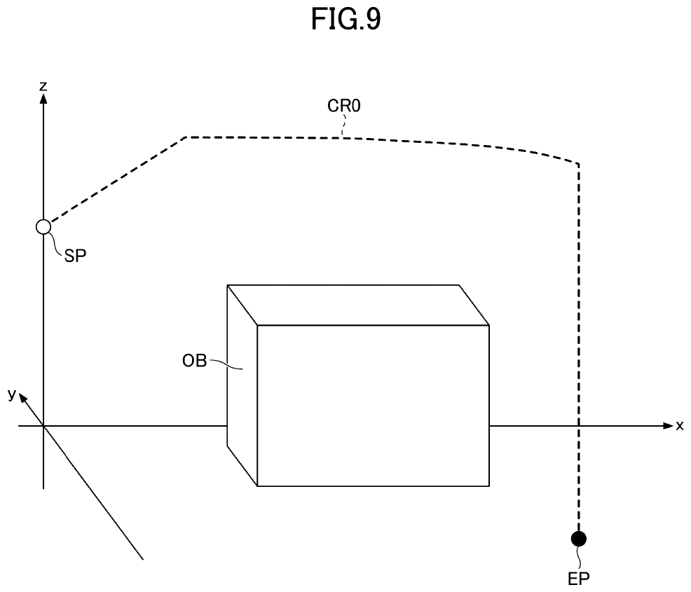

FIG. 9 is an example of an image showing a transport path CR0 of the suspended load generated by the controller 10. In the example illustrated in FIG. 9, the transport path CR0 is three-dimensionally displayed by straight and curved lines in a three-dimensional orthogonal coordinate system. In the example illustrated in FIG. 9, an image is displayed, including the start position SP and the end position EP of transporting the suspended load in a three-dimensional orthogonal coordinate system and the obstacle OB such as a building that affects the transport path CR0.

If the transport path CR0 cannot be generated in Processing P04, the controller 10 may, in Processing P05, cause the display device D1 to display information indicating that the transport path CR0 cannot be generated. Specifically, suppose that the transport path generation unit 103 is unable to generate the transport path CR0 based on the designated path DR in Processing P04 due to, for example, interference between the crane 1 or the suspended load and the obstacle OB. Then, in Processing P05, the transport path generation unit 103 generates, for example, image data indicating that the transport path CR0 based on the designated path DR cannot be generated and outputs the generated image data to the display device D1 to display, on the display device D1, an error in generating the transport path CR0.

Next, as illustrated in FIG. 7, the controller 10 executes Processing P06 in which the operator inputs whether the transport path needs to be corrected. In Processing P06, for example, the transport path generation unit 103 causes the display device D1 to display an image for checking whether or not the transport path CR0 needs to be corrected, and receives an input as to whether or not the transport path CR0 needs to be corrected by the operator via the input device D2. Thereafter, the controller 10 executes Processing P07 to determine whether the transport path CR0 needs to be corrected.

If the operator inputs to the input device D2 in Processing P06 that the transport path CR0 does not need to be corrected, the transport path generation unit 103 determines in Processing P07 that the transport path CR0 does not need to be corrected (NO). In this case, the controller 10 executes Processing P08 to transport the suspended load. Then, in Processing P08, the transport control unit 104 acquires the detection result from the sensor SN, outputs a control command to the proportional control valve 15, and controls the control valves of the control valve unit 13. Accordingly, the flow rate and direction of the hydraulic fluid supplied from the main pump 12 to the actuators, such as the slew motor 3A, the front motor 3Mf, the rear motor 3Mr, and the boom-luffing motor 3Mb, are controlled.

As a result, the slew device 35, the front winch 37f, the rear winch 37r, the boom-luffing winch 37b, and the like of the crane 1 are driven as necessary, and slewing of the upper structure 3, luffing of the attachment AT, and raising or lowering of the hook, such as the boom hook 81, are performed as necessary. Then, the suspended load hooked to the hook is automatically transported following the transport path CR0 from the start position SP to the end position EP.

The controller 10 thus controls slewing of the upper structure 3, luffing of the attachment AT, or raising and lowering of the hook and transports the suspended load following the transport path CR0. Thereafter, the controller 10 ends the processing flow illustrated in FIG. 7. Note that, in Processing P08, for example, the transport control unit 104 may switch the operation of some actuators, such as the front motor 3Mf for raising and lowering the boom hook 81, to a manual operation performed by the operator with the operating device OD.

On the other hand, if the operator inputs to the input device D2 in Processing P06 that the transport path CR0 needs to be corrected, the transport path generation unit 103 determines in Processing P07 that the transport path CR0 needs to be corrected (YES). In this case, the controller 10 executes Processing P09 for selecting a mode.

In Processing P09, for example, the transport path generation unit 103 causes the display device D1 to display mode options for correcting the transport path CR0, and receives, via the input device D2, the mode selected by the operator. The modes available for operator selection include, for example, a plurality of modes in which different indices are prioritized in the transport path for the suspended load. Herein, the indices to be prioritized in the transport path for the suspended load include, for example, a productivity index in transporting the suspended load, an energy-saving index, or a safety index.

That is, the modes selectable by the operator include, for example, a productivity-priority mode, an energy-saving mode, and a safety mode. The productivity-priority mode is a mode that improves productivity in transporting the suspended load by, for example, shortening the length of the transport path, which serves as the productivity index in transporting the suspended load. The energy-saving mode is a mode that improves energy-saving performance in transporting the suspended load by, for example, suppressing changes in the potential energy of the suspended load, which serves as the energy-saving index. The safety mode is a mode that improves safety in transporting the suspended load by, for example, providing a margin for the minimum distance between the suspended load and the obstacle OB, which serves as the safety index.

Thereafter, the controller 10 executes Processing P10 to correct the transport path CR0. Specifically, when the mode selected by the operator in Processing P09 is input via the input device D2, an index to be prioritized in the transport path for the suspended load is input to the transport path generation unit 103 in accordance with the selected mode. Then, in Processing P10, the transport path generation unit 103 corrects the transport path CR0, which serves as the initial path generated in Processing P04, based on the input index to be prioritized.

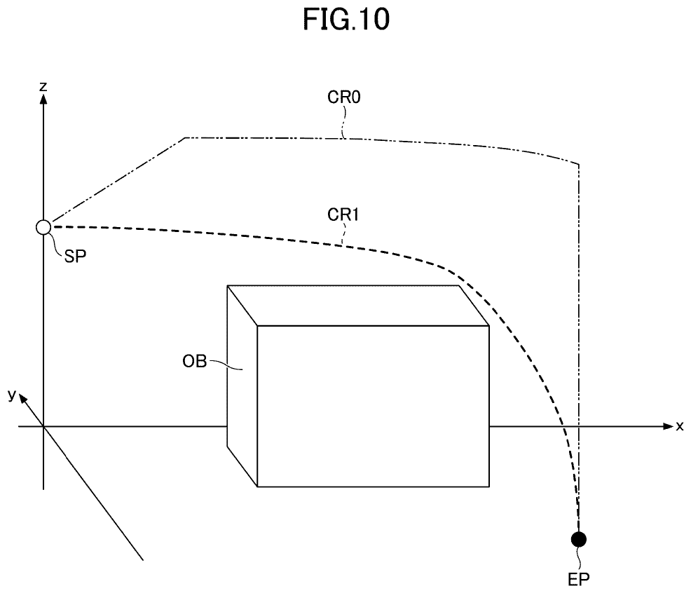

FIG. 10 is an example of an image showing a transport path CR1 for the suspended load generated by the controller 10. In Processing P10, the transport path generation unit 103 corrects the transport path CR0, which is generated as the initial path, in accordance with the input mode, and then generates the new transport path CR1. In the example illustrated in FIG. 10, the productivity priority mode is selected in Processing P09, and the transport path generation unit 103 generates the transport path CR1 in which the path length from the start position SP to the end position EP is made shorter than the original transport path CR0 without interfering with the obstacle OB and within the movable range of the crane 1.

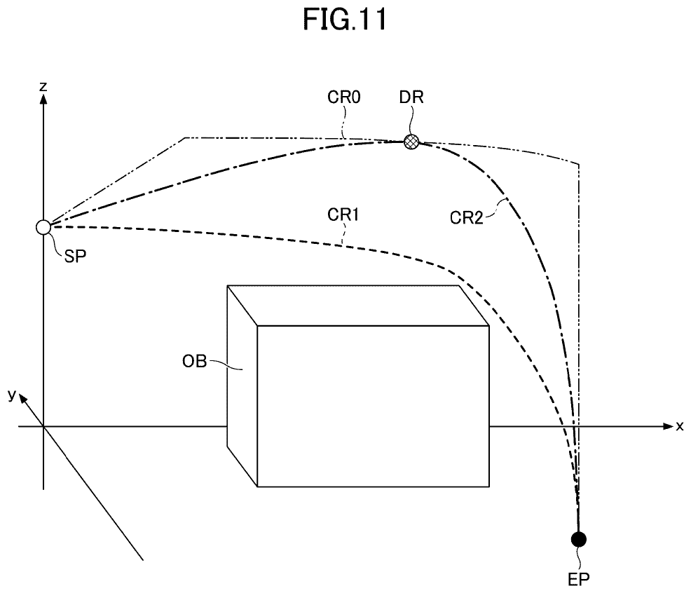

FIG. 11 is an example of an image showing a different transport path CR2 for the suspended load recorrected by the controller 10. In the example illustrated in FIG. 11, the operator recorrects the transport path CR1, which has been corrected by the controller 10, for example, by selecting the productivity priority mode. The operator inputs the designated path DR as a point in a three-dimensional coordinate system to the controller 10 by touching the touch panel TP, for example. Then, in Processing P10, the transport path generation unit 103 generates a new transport path CR2 by correcting the transport path CR1 so as to pass through the input designated path DR.

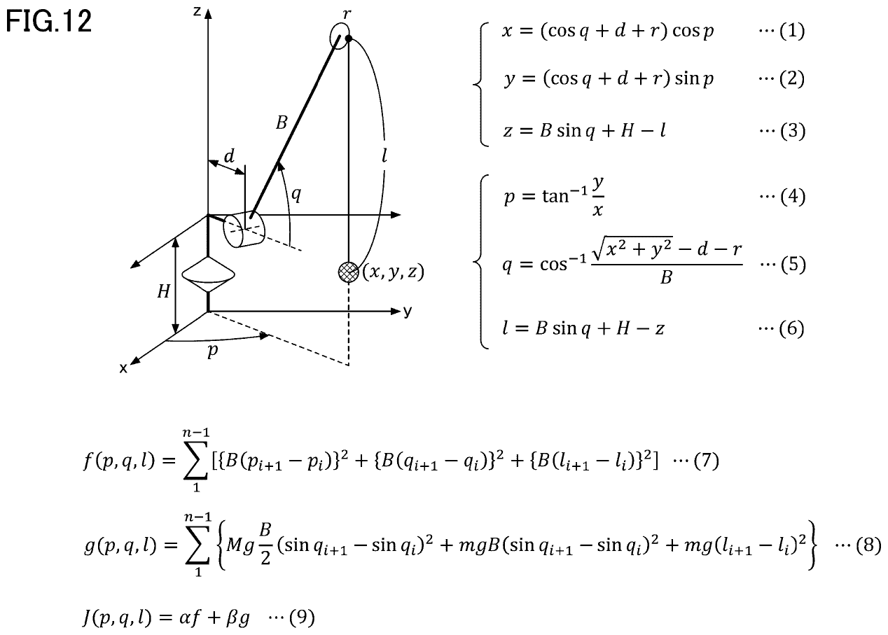

FIG. 12 is a diagram showing an example of a crane model and an evaluation function J. The transport path generation unit 103 can generate a transport path for a suspended load prioritizing productivity or a transport path for a suspended load prioritizing energy-saving performance by using the crane model and the evaluation function J shown in FIG. 12, for example. The crane model shown at the upper left of FIG. 12 is a model of the crane 1 in a three-dimensional orthogonal coordinate system including the x-axis, the y-axis, and the z-axis.

In the crane model of FIG. 12, H is a height from a reference plane such as the ground surface to the rotation center axis of the boom foot pin provided in the upper structure 3 for rotatably supporting the attachment AT. B is a length of the attachment AT from the center axis of the boom foot pin to the sheave provided at the distal end of the attachment AT. r is a radius of the sheave provided at the distal end of the attachment AT. d is a distance from the center axis of the boom foot pin to the slew center axis of the upper structure 3. The slew center axis of the upper structure 3 coincides with the z-axis.

In the crane model of FIG. 12, p is a slewing angle of the upper structure 3, and q is a luffing angle of the attachment AT. 1 is a rope length, which is a distance from the sheave at the distal end of the attachment AT to the suspended load hooked to the hook hung by a wire rope. In this crane model, as shown in Equations (1) to (3) in FIG. 12, the coordinates (x, y, z) of the suspended load can be expressed by a function using the above-described slewing angle p, luffing angle q, distance d, radius r, length B, height H, and rope length l.

As shown in Equations (4) to (6) in FIG. 12, the slewing angle p, the luffing angle q, and the rope length l can be expressed by respective functions using the coordinates (x, y, z) of the suspended load, the distance d, the radius r, the length B, the luffing angle q, and the height H. A three-dimensional orthogonal coordinate system having the slewing angle p, the luffing angle q, and the rope length l as axes is referred to as a configuration space. The transport path generation unit 103 optimizes the transport path for the suspended load, for example, by using the configuration space.

Specifically, the transport path generation unit 103 generates a transport path for the suspended load using an evaluation function J(p, q, l) of a function f(p, q, l) of the path length of the transport path and a function g(p, q, l) of the potential energy, as shown in Equations (7) to (9) in FIG. 12. In the evaluation function J(p, q, l), a and B are both weights. That is, in the evaluation function J(p, q, l), if a is increased and B is decreased, a transport path in which the path length of the transport path is shortened and the productivity is prioritized is generated, and if B is increased and a is decreased, a transport path in which the potential energy change of the transport path is suppressed and the energy saving is prioritized is generated.

In the square brackets of the sum for the function f(p, q, l) of the path length shown in Equation (7), the first term represents a path length defined by slewing, the second term represents a path length defined by luffing, and the third term represents a path length defined by the wire length. Equation (7) shown in FIG. 12 is an example and is not particularly limited. Specifically, as shown below, in Equation (7), the function f(p, q, l) of the path length is at least an equation representing the length of a line segment from the start position SP to the end position EP.

$$f ( p , q , 1 ) = \{ Length of Line Segment from Start Position SP to End Position EP \} \qquad ( 7 )$$

In the curly brackets of the sum for the function g(p, q, l) of potential energy shown in Equation (8), the first term, the second term, and the third term represent the potential energy of the luffing of the attachment AT, the potential energy of the suspended load, and the potential energy of the wire, respectively. Equation (8) shown in FIG. 12 is an example and is not particularly limited. Specifically, as shown below, in Equation (8), the function g(p, q, l) of potential energy is at least an equation including the sum of the potential energy change accompanying the change of the luffing angle q of the attachment AT and the potential energy change accompanying the change of the rope length l.

$$g ( p , q , 1 ) = \{ Potential Energy Change Accompanying Change of Luffing Angle q \} + \{ Potential Energy Change Accompanying Change Of Rope Length 1 \} \qquad ( 8 )$$

{Length of Line Segment from Start Position SP to End Position EP} in Equation (7) is obtained, for example, by integrating the length of the line segment connecting the position coordinates on the transport path for the suspended load. As for Equation (8), these can be obtained by integrating the potential energy of the attachment AT expressed by (½)×MgB×sinq and the potential energy of the suspended load expressed by (½)×mgB×(sinq+1).

As described above, the controller 10 corrects the transport path CR0 by using, for example, the evaluation function J(p, q, l) including the function f(p, q, l) of the path length which is a productivity index and the function g(p, q, l) of the potential energy which is an energy-saving index. Note that the evaluation function J(p, q, l) may include, in addition to the functions f(p, q, l) and g(p, q, l), a function h (p, q, l) expressing a distance between the obstacle OB and the transport path for the suspended load.

Thereafter, the controller 10 repeats Processing P05 to Processing P07 illustrated in FIG. 7. In the process, if the operator inputs to the input device D2 in Processing P06 that transport path CR1 does not need to be corrected, the transport path generation unit 103 determines in Processing P07 that the transport path CR1 does not need to be corrected (NO). Thereafter, the controller 10 automatically transports the suspended load following a new transport path CR1 Processing P08, as described above, and ends the processing flow illustrated in FIG. 7.

The effects of the crane 1 according to the present embodiment will be described below.

As described above, the crane 1 of the present embodiment includes the upper structure 3 which is provided so as to be capable of slewing, the attachment AT which is provided to the upper structure 3 so as to be capable of being luffed, and a hook such as the boom hook 81 which is hung so as to be capable of being raised and lowered via the attachment AT. The crane 1 further includes the input device D2 and the controller 10. The input device D2 is configured to input the designated path DR between the start position SP and the end position EP of transporting the suspended load with a hook. The controller 10 generates the transport path CR0 for the suspended load from the start position SP of transporting the suspended load to the end position EP of transporting the suspended load via the designated path DR input to the input device D2.

With this configuration, before the controller 10 generates the transport path CR0 for the suspended load, the operator of the crane 1 can input, via the input device D2, the designated path DR that conforms to the operator's sense and intention of operation when the operator operates the crane 1 to transport the suspended load. This enables the controller 10 to generate the transport path CR0 based on the designated path DR that conforms to the operator's sense and intention of operation. Therefore, according to the crane 1 of the present embodiment, it is possible to automatically generate the transport path CR0 for the suspended load that conforms to the operator's sense of operation. In addition, it is not necessary for the controller 10 to determine whether or not the transport path CR0 passing over the obstacle OB is acceptable, and the calculation load of the controller 10 can be reduced.

In the crane 1 of the present embodiment, the designated path DR includes one or more points in a three-dimensional coordinate system.

With this configuration, when the operator of the crane 1 simply inputs one point via the input device D2, the transport path CR0 reflecting the operator's sense and intention of operation can be generated by the controller 10, and the input load of the operator can be reduced. In addition, by increasing the number of points input by the operator of the crane 1 via the input device D2, the transport path CR0 further reflecting the operator's sense and intention of operation can be generated. Note that, by increasing the number of points input by the operator of the crane 1 via the input device D2, the designated path DR including straight and curved lines as illustrated in FIG. 8 can be generated. Thus, the transport path CR0 further reflecting the operator's sense and intention of operation can be generated.

In the crane 1 of the present embodiment, when an index to be prioritized in the transport path CR0 is input via the input device D2, the controller corrects the transport path CR0 based on the index.

With this configuration, the transport path CR0 that conforms to the operator's sense and intention of operation is generated, and the transport path CR0 is corrected based on the index to be prioritized, so that the corrected transport path CR1 also conforms to the operator's sense and intention of operation.

In the crane 1 of the present embodiment, the above index includes the productivity index, the energy-saving index, or the safety index in transporting the suspended load.

With this configuration, the transport path CR0 that conforms to the operator's sense and intention of operation can be generated, and the transport path CR0 can be corrected based on the index. Therefore, according to the crane 1 of the present embodiment, it is possible to generate the transport path CR1 that conforms to the operator's sense and intention of operation and is excellent in productivity, energy-saving performance, or safety.

In the crane 1 of the present embodiment, the controller 10 corrects the transport path CR0 by using the evaluation function J(p, q, l) including the function f(p, q, l) of the path length which is the productivity index and the function g(p, q, l) of the potential energy which the energy-saving index.

With this configuration, after the transport path CR0 that conforms to the operator's sense and intention of operation is generated, the transport path CR0 is corrected by using the evaluation function J(p, q, l), and the transport path CR1 that is excellent in productivity or the transport path CR1 that is excellent in energy-saving performance can be generated. By adjusting the weight a of the function f(p, q, l) of the path length and the weight B of the function g(p, q, l) of the potential energy in the evaluation function J(p, q, l), the balance between the productivity and the energy-saving performance in the corrected transport path CR1 can be freely changed.

The crane 1 of the present embodiment further includes the display device D1 configured to display the transport paths CR0 and CR1 generated by the controller 10.

With this configuration, the operator or the manager of the crane 1 can visually check the transport paths CR0 and CR1 displayed on the display device D1. Therefore, the operator can check whether or not the transport paths CR0 and CR1 generated by the crane 1 conform to the operator's sense and intention of operation with the image displayed on the display device D1.

In the crane 1 of the present embodiment, when the transport path CR0 cannot be generated, the controller 10 causes the display device D1 to display information indicating that the transport path CR0 cannot be generated.

With this configuration, the operator of the crane 1 can check the information indicating that the transport path CR0 cannot be generated displayed on the display device D1 and recognize that the designated path DR input to the input device D2 by the operator is incorrect.

In the crane 1 of the present embodiment, the input device D2 configured to input the designated path DR is the touch panel TP provided on the display device D1.

With this configuration, the operator of the crane 1 can input the designated path DR by tracing the touch panel TP provided on the display device D1 according to the operator's sense and intention of operation while referring to the obstacle OB and the crane 1 at the work site displayed on the display device D1. Therefore, it is possible to easily input the designated path DR further reflecting the operator's sense and intention of operation.

In the crane 1 of the present embodiment, the controller 10 controls slewing of the upper structure 3, luffing of the attachment AT, or raising and lowering of the hook such as the boom hook 81 and transports the suspended load following the transport paths CR0 and CR1.

With this configuration, even a non-skilled operator can efficiently and safely transport the suspended load by the crane 1 following the transport paths CR0 and CR1 that conform to the operator's sense and intention of operation.

The preferred embodiments of the present disclosure have been described above. However, the invention of the present disclosure is not limited to the above-described embodiments. Various modifications, substitutions, and the like can be applied to the embodiments described above without departing from the scope of the present invention of the present disclosure. Each of the features described with reference to the above-described embodiments may be suitably combined provided that there is no technical inconsistency.

What is claimed is:

1. A crane comprising:
an upper structure provided so as to be capable of slewing;
an attachment provided on the upper structure so as to be capable of being luffed;
a hook that is hung so as to be capable of being raised and lowered via the attachment;
an input device configured to input a designated path between a start position and an end position of transporting a suspended load with the hook; and
a controller comprising: a memory; and a processor coupled to the memory and configured to generate a transport path for the suspended load from the start position to the end position via the designated path input to the input device.

2. The crane according to claim 1, wherein
the designated path includes one or more points in a three-dimensional coordinate system.

3. The crane according to claim 1, wherein
the processor is further configured to correct the transport path based on an index to be prioritized in the transport path when the index is input via the input device.

4. The crane according to claim 3, wherein
the index is a productivity index, an energy-saving index, or a safety index in transporting the suspended load.

5. The crane according to claim 4, wherein
the processor is further configured to correct the transport path by using an evaluation function including a function of a path length and a function of potential energy, the function of the path length being the productivity index, and the function of the potential energy being the energy-saving index.

6. The crane according to claim 1, further comprising:
a display device configured to display the transport path generated by the processor.

7. The crane according to claim 6, wherein
the processor is further configured to cause the display device to display information indicating that the transport path cannot be generated when the transport path cannot be generated.

8. The crane according to claim 6, wherein
the input device is a touch panel provided on the display device.

9. The crane according to claim 1, wherein
the processor is further configured to control slewing of the upper structure, luffing of the attachment, or raising and lowering of the hook and transport the suspended load following the transport path.

10. The crane according to claim 1, wherein
the processor is further configured to
store three-dimensional information on the crane,
store three-dimensional map information on a work site where the crane operates,
generate the transport path based on the three-dimensional information, the three-dimensional map information, and the designated path received via the input device, and
control an actuator of the crane so that the suspended load is moved following the transport path.

11. The crane according to claim 10, wherein
the processor is further configured to cause a display device to display mode options for correcting the transport path, and correct the transport path in accordance with a mode selected via the input device.

12. The crane according to claim 11, wherein
the mode is a productivity-priority mode, an energy-saving mode, or a safety mode.

13. The crane according to claim 12, wherein
the processor is further configured to improve productivity in transporting the suspended load by shortening a length of the transport path when the productivity-priority mode is selected.

14. The crane according to claim 12, wherein
the processor is further configured to improve energy-saving performance in transporting the suspended load by suppressing a change in potential energy of the suspended load when the energy-saving mode is selected.

15. The crane according to claim 12, wherein
the processor is further configured to improve safety in transporting the suspended load by providing a margin for a minimum distance between the suspended load and an obstacle when the safety mode is selected.
